(19) United States
(12) Patent Application Publication
(10) Pub. No.: US 2009/0319584 A1
(43) Pub. Date: Dec. 24, 2009

(54) System and method for managing electronic mail and documents

(76) Inventor: Michael R. Song, Guilford, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 12/454,183

(22) Filed: May 13, 2009

Related U.S. Application Data
(60) Provisional application No. 61/052,752, filed on May 13, 2008.
(60) Provisional application No. 61/073,402, filed on Jun. 18, 2008.

(51) Int. Cl. G06F 17/30

(52) U.S. Cl. 707/204; 707/E17.005

(57) ABSTRACT

A system and method is presented for managing electronic data and information such as electronic mail messages and/or documents to maximize efficient storage thereof. The method includes categorizing electronic mail messages and/or documents present in a plurality of storage devices or locations in relation to storage size requirements of each; and invoking an interactive metaphor by which a plurality of users selectively identify subsets of the categorized messages and once identified the subset of documents and messages are at least one of stored in a secondary storage device or location that is different from the primary storage device or location and deleting the document or message from the primary storage device or location. In one embodiment, the primary storage location is comprised of electronic mail Sent, Calendar Inbox, and Deleted (SCID) folders, and the interactive metaphor is comprised of a fishing metaphor.

### CROSS-REFERENCE TO RELATED APPLICATIONS

This patent application claims priority benefit under 35 U.S.C. §119(e) of copending, U.S. Provisional Patent Applications, Ser. Nos. 61/052,752, filed May 13, 2008, and 61/073,402, filed Jun. 18, 2008. The disclosures of these U.S. patent applications are incorporated by reference herein in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### FIELD OF THE INVENTION

This invention relates to systems and methods for managing information and, in particular, to systems and methods for managing electronic information such as, for example, electronic mail messages and documents for efficient use of storage devices.

### BACKGROUND OF THE INVENTION

Corporations are spending a great deal of money backing up user electronic information including documents and electronic mail messages, commonly referred to as “email.” By 2009, it is estimated that professionals will send about 276 billion emails per day. According to The Radicati Group, Inc. in “Market Numbers Quarterly Update,” April 2005, the typical corporate user generates 19.5 megabytes (MBs) of email every day which equates to 4,680 MBs per year. According to researcher Norbert Haag in “Expert Knowledgebase,” October 2003, the cost of managing the storage of a megabyte of information can be 8 cents or more. This means that storage costs per user per year are roughly $374 (USD). Extrapolated across a 10,000 person organization, this results in an annual cost of email back up in excess of $3.7 million dollars (USD) per year. Document storage requirements are also seeing such systemic growth.

These estimates do not include the cost of servers, additional IT staff, and other so called “soft” costs. Email volume is thought to be escalating at a rate of fifteen percent (15%) per year which means that IT departments are constantly required to buy more servers to back up email.

In the case of email, one problem is that each night all employees' Sent, Calendar Inbox, and Deleted (SCID) folders are duplicated onto a multitude of secondary storage devices such as tapes that are then sent to a storage facility such as, for example, an offsite storage facility. Document information stored on servers, hard drives, etc. is backed up but may or may not be sent offsite.

For years IT Departments have complained that back up costs are eating away a huge chunk of their total budget with no end in sight. Some solutions have been offered by Email Software manufacturers like Microsoft Corporation (Redmond, Wash. USA). For example, Microsoft has created a Mailbox Clean Up Tool. Unfortunately, most users do not use the tool as there is little time during an employee's busy day or reward for doing so. IT Directors have complained to the inventor that they view this problem as a behavioral issue. For example, employees simply refuse to stop sending and saving large emails. Yet, in some instances it seems that IT leaders have failed to provide specific guidelines or instructions for doing so. In particular, they have failed to explain that the vast majority of email mass is packed into a small number of high MB messages.

Some companies have responded to the demand for storage by instituting a “nasty gram” campaign (e.g., broadcasted email messages) that alerts users that their email inboxes have exceeded a corporate limit of X number of megabytes. These messages are resented by employees who get extremely upset when, as a penalty, their email accounts are shut down. Some corporations have set auto-deletion policies that remove any email older than, for example, about sixty to ninety (60-90) days from user's inboxes. Auto-deletion may also be used in the cases where a document has not been accessed in a predetermined time period. This strategy can cause the unintentional loss of valuable business and/or personal information and data, and may even result in violations of regulations that demand corporations maintain lasting records of some business information and data.

In view of the above, the inventor, an innovator in providing email efficiency and etiquette and document handling solutions, is introducing a solution. The solution includes a system and method, implemented in one embodiment as an electronic software gaming system provided under an iFISH5™ brand (iFISH5 is a trademark of Cohesive Knowledge Solutions, Inc., Guilford, Conn.). The iFish5 system provides a simple, fun, and rewarding means (e.g., game) that helps employees locate and delete or save email and/or documents rapidly thus maximizing the efficiency by which email messages and documents are stored. The iFish5 system assists a user by identifying the largest emails in their SCID folders and/or documents in system storage with minimal effort, e.g., taking only about five (5) minutes per week to play. In one embodiment, the iFish5 system targets a small number of high megabyte (MB) email messages and documents. By reducing the amount of emails and documents stored by, for example, twenty-five to fifty percent (25-50%) the iFish5 system can save a 10,000 person corporation roughly about $1,000,000 (USD) per year.

### BRIEF DESCRIPTION OF THE DRAWINGS

FIG. 1 is a simplified schematic block diagram of a iFISH5™ system providing enhanced computer storage, in accordance with one embodiment of the present invention;

FIG. 2 is a representation of a graphical user interface depicting an electronic document and mail (email) message reduction program, in accordance with one embodiment of the present invention; and

FIG. 3 is a graphical representation of symbols used to represent documents and messages targeted based on a predetermined characteristic such as size (in terms of bytes of data stored), in accordance with one embodiment of the present invention.

### DETAILED DESCRIPTION OF PREFERRED EMBODIMENTS

The present invention provides a novel system and method described herein under an iFISH₅™ brand name (iFISH5 is a trademark of Cohesive Knowledge Solutions, Inc., Guilford, Conn.). The iFISH5™ system identifies and reallocates electronic infonnation and data in memory of computing devices. The information and data is identified by a characteristic such as, for example, its content or capacity required to store the information and data in an electronic memory device or resource of a computer or network of computers. Data is reallocated by transferring the data from a first memory device and/or location, storing the data in a second memory device and/or location, and deleting the data from the first memory device and/or location. In one embodiment, the first memory device and/or location is periodically duplicated (e.g., backed up) such as in typical locations and devices containing valuable business infonmation and data. In one embodiment, the second memory device and/or location is not subject to the aforementioned duplication such as in typical locations and devices containing less valuable business and/or personal infonmation and data.

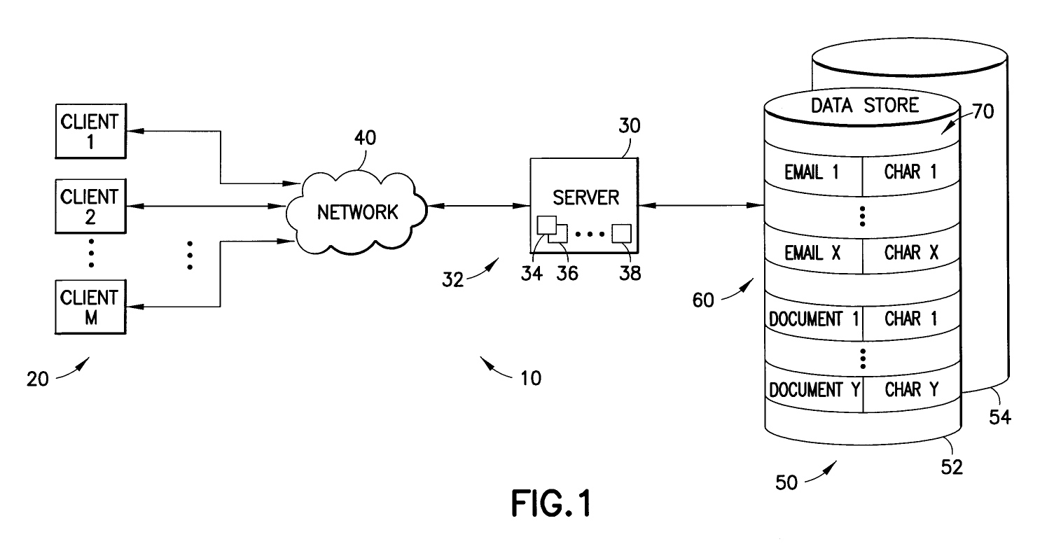

In FIG. 1, an exemplary implementation of the iFISH5 ™ system, shown generally at 10, is provided on one or more general purpose computers, work stations, and portable computing devices such as, for example, a personal digital assistant (PDA), laptop computer or the like. In FIG. 1, the iFISH5™ system 10 includes a plurality of client devices (e.g., Client 1-M), shown generally at 20, operative coupled to a server device 30 over a communication network 40 such as, for example, the Internet, an intranet, an extranet, or like distributed communication platform connecting computing devices over wired and/or wireless connections. As is known to those skilled in the art, the client devices 20 and server 30 each include a processor, computer-readable medium or memory, and input-output devices including devices for facilitating communication over the network 40. The processor executes program instructions stored in the memory such that persons operating individual ones of the client devices 20 communicate over the network 40 with other client devices 20 as well as other computing devices coupled to the network, such as the server device 30. It should be appreciated that the lient devices 20 include, for example, a personal computer (PC), workstation, laptop, tablet computer, personal digital assistant, pocket PC, Internet-enabled mobile radiotelephone, pager or like portable computing devices.

As shown in FIG. 1, the server 30 is coupled to a data store, shown generally at 50. It should be appreciated that the data store 50 may be a relational data base, object oriented data base or other suitable data repository, as is known in the art. In one embodiment, the data store 50 stores one or more forms of electronic data and information 60 such as, for example, a plurality of email messages 62 (e.g., email 1 to email x) and a plurality of documents 64 (e.g., document 1 to document y). As is generally known in the art, the data store 50 may include a plurality of memory devices 52 and 54 storing the electronic data and information files 60, e.g., the plurality of email messages 62 and the plurality of documents 64. The content of the data and information files 60, in accordance with one embodiment of the present invention, is accessed by persons (e.g., users of the system 10) operating one of the client devices 20 by connecting to the server 30. For example, the server 30 hosts one or more user interfaces, e.g., application generated user interfaces, web pages, and the like, shown generally at 32, that are requested by the users. In one embodiment, access to the iFISH5™ system 10 and user interfaces 32, server 30, the data store 50, selected portions thereof, and/or to selected services and functionality provided by the system 10, is restricted to registered users (e.g., “member”), as is described below. The client devices 20 execute application programs such as, for example, web browser softw are to request, receive and process the user interfaces 32.

It should be appreciated that it is within the scope of the present invention for the client 20 and server 30 computing devices described herein above as being networked to broadly define all computers. For example, the iFISH5™ system 10 can be implemented as software running on a personal computer (e.g., a PC with an Intel processor or an Apple Macintosh) capable of running an operating system such as one of the Microsoft Windows family of operating systems from Microsoft Corporation (Redmond, Wash.), the Macintosh operating system from Apple Computer (Cupertino, Calif.), and various varieties of Unix systems, such as Sun Solaris from Sun Microsystems, and Linux from Red Hat, Inc. of Durham, N.C. (and others). Moreover, iFISH5™ system 10 could also be implemented on such hardware as a smart or dumb terminal, network computer, personal data assistant, wireless device, information appliance, workstation, minicomputer, mainframe computer, kiosk, or other computing device, that is operated as a general purpose computer or a special purpose hardware device as is known in the art. As is generally known, each of the computing devices may include a central processing unit (CPU), computer readable memory for storing the algorithms, process variables and data for executing the algorithms, and a display device such as, for example, a pixel-oriented display device for exhibiting results of the algorithms including, for example, visual representations of the data and information 60 described herein. It should also be appreciated that the computer-implemented steps generally require manipulation of data in the fonm of electrical, magnetic and/or optical signals that may be stored, transferred, combined, compared, or otherwise manipulated to provide a desired result. In one embodiment, a desired result includes visual representations of one or more data and infonmation 60 files.

In one embodiment of the iFISH5™ system 10, relatively large volume electronic mail messages (emails) and documents 60 are identified by. characteristics (char 1-char x, char 1-char y) 70 such as content, size, and the like, and reallocated between memory devices 50 and/or locations within the devices 50 to reduce overall storage requirements and thus, more efficiently utilize the storage capacity of the computer or network of computers operating within the system 10. As described above, individuals concerned with the increasing cost of maintaining the storage devices are seeking the assistance of computer users under their supervision (e.g., the users of the client devices 20). A challenge to this effort is that busy employees have little incentive to personally identify and reallocate storage resources to minimize cost. As such, few users delete unneeded or less important electronic data and information such as, for example, a large email message that contains a twenty megabytes (20 MB) PowerPoint presentation. Purging emails is neither a fun nor rewarding activity and therefore a huge amount of information is needlessly backed up each night at a cost that can reach millions of dollars per year for larger organizations. In some cases, large email messages sit in a person's Deleted Folder for months. Other times ten messages with various versions of an attachment reside simultaneously in two or three SCID folders.

In view thereof, the inventor proposes a solution, a system and method for identifying and reallocating electronic infonmation and data such as email messages for more efficient utilization of storage requirements. In one embodiment, the iFish5 system 10 is implemented as a game that enterprises can install to motivate users to reallocate and/or delete infonnation and data that is consuming relatively large storage resources (e.g., email messages of about 250 Kilobytes and above) from users' SCID folders on a periodic basis. In one embodiment, the iFish5 system 10 is implemented as a game using an interactive “fishing” metaphor to entice the user to spend about five (5) minutes a week in identifying and locating their largest documents and emails. For example, in one embodiment, a “Target Fish” is an email message having a characteristic (e.g., storage size) of over a predetermined minimum threshold of, for example, the aforementioned about 250 Kilobytes size. The user then plays a game to see how many unneeded documents and emails can be reallocated, deleted or saved to a less expensive, non-backed up, alternative location such as a designated network server, a personal storage space (e.g., removable memory card, C: drive, Shared Document storage site, etc.).

The act of “fishing” for (identifying) big virtual info-fish (iFish) focuses the employee on deleting a small number of relatively large documents and emails that contain the largest mass of stored data. The inventor has recognized that that roughly five percent (5%) of stored emails contain ninety-five percent (95%) of the total megabytes of stored information. In view thereof, it makes sense for users to focus on the larger iFish (documents and/or emails) first. Simply stated:

Fun+Rewarding+Prioritization=Maximum Docs/Email MBs deleted.

In one embodiment, with reference to FIGS. 1-3, the iFish5 system 10 is implemented as follows.

1. The iFish5 system 10 is installed on computing devices (client devices 20 and server 30) at a user, team, department, division, or enterprise level of organization.

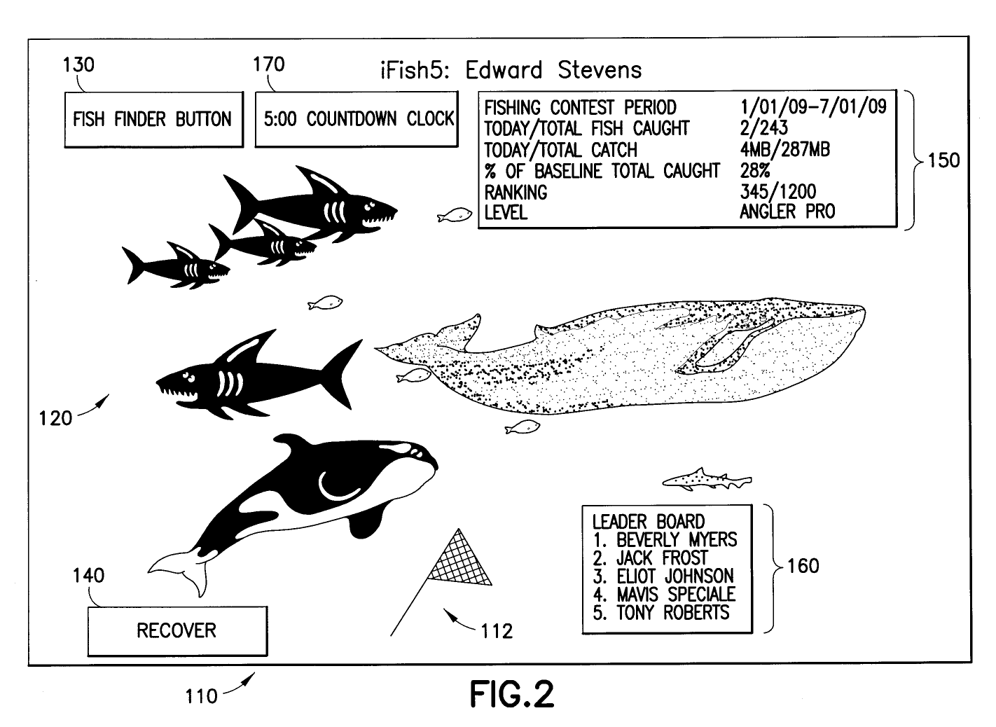

2. The iFish5 system 10 executes and studies current number and mass of documents and emails stored in the data store 50 for an individual and a group, and develops a baseline number of, for example, about four hundred megabytes (400 MBs) for an individual (as shown in FIG. 2, an individual referred to as “Ed Stevens”) and a number of about 1.2 terabytes for an organization (in this example, an organization referred to as “Standard Fixture Marketing Team”).

3. The user launches the program and receives a summary of large documents and emails stored in each SCID folder of the data store 50.

4. Next, on a display device of the client device 20 operated by the user, the user is shown a user interface 110 (e.g., one of the interfaces 32) having a plurality of graphical representations 120 of their data and information 60 as “fish” swimming across the display device (FIG. 2). Each iFish 120 represents a document and/or email message associated to the user that is stored in the system 10. The user may then select, for example, a “Fish Finder”button 130. In response, the iFish5 system 10 identifies and extracts a predetermined number of large fish, e.g., the five (5) largest (by size in bytes) documents and/or email messages and prompts the user to “catch” the fish, which continue to swim around the interface 110. In one embodiment, the predetermined number of fish, e.g., the five (5) largest iFish 120 appear to be swimming across the interface 110 in a rich looking three-dimensional ocean of water. When a cursor 112 of a mouse (or other pointing device) of the computing device approaches the iFish 120, the cursor 112 turns into a fishing net. In one embodiment, a message appears that says, for example, “Use your net to catch the biggest fish first! You have just 5 minutes!”

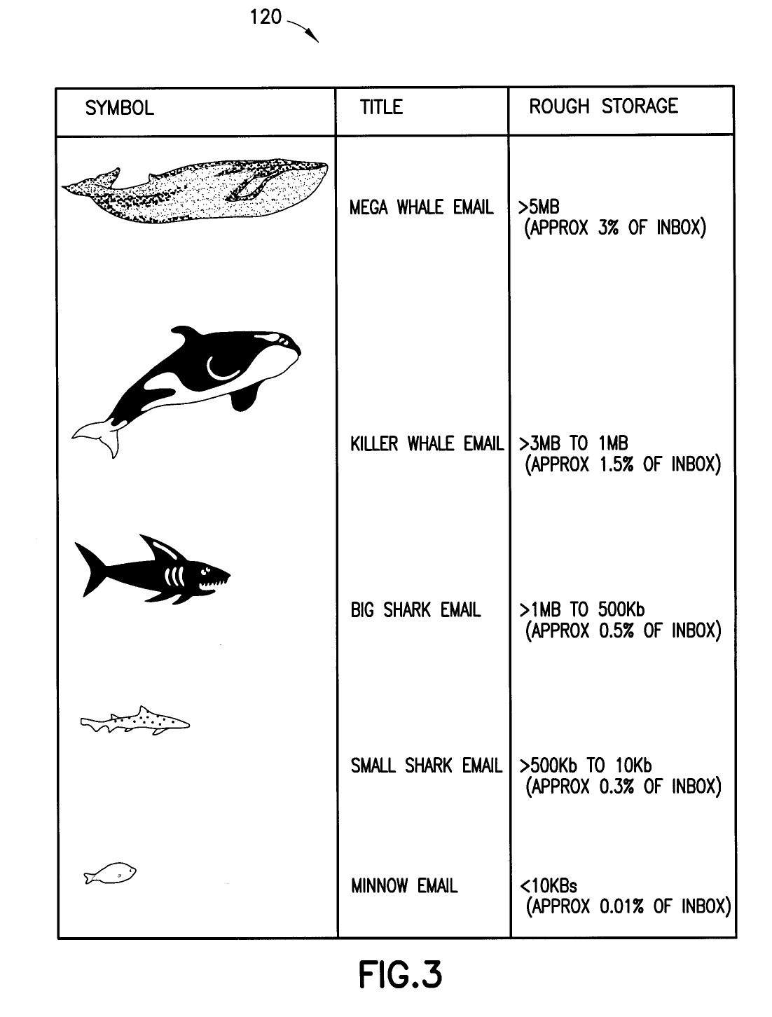

The iFish 120 “swim” across the screen 110 quickly enough to make it slightly challenging to catch them but about ninety-nine percent (99%) of users will be able to catch the iFish 120 with a modest effort. In some cases, a large iFish 120 might be swimming far away and therefore look smaller, so users have to be alert to catching the largest iFish. In one embodiment, other sea creatures may occasionally traverse the screen 110 of the display device to keep the game/fishing effort interesting. iFish 120 may be a size relative to a predetermined characteristics 70 such as, for example, relative importance or lack thereof of the contents (e.g., “junk mail” is larger), storage requirements namely the megabytes of storage required to retain the information and data (e.g., large files are big iFish 120). In one embodiment illustrated in FIG. 3, different sized iFish 120 are in each of, for example, five (5) iFish categories represented graphically as, for example, a mega whale (for documents or emails>5 MB in size), a killer whale (for documents and emails>3 MB<5 MB), big shark (for documents or emails>1 MB<3 MB), a small shark (for documents or emails>500 Kb<1 MB) and a minnow (for documents or email>10 Kb<500 Kb). Below is an example of what is exhibited on the display (e.g., interface 32) to a users before hitting the Fish Finder button 130.

5. When the user manipulates the cursor (net) 112 over an iFish 120 its characteristics and/or statistics pop up. For example, the iFish5 system 10 may exhibit the size, title and storage location (SCID folder) of origin, etc., of the selected iFish 120. The iFish5 system 10 may then present the user with an option of saving the whole document or email to another storage location (e.g., a non-SCID email folder), save just the attachment to another drive, delete the document or email, keep the document or email, or put it in a “pool” to tag it for later review. FIG. 3 illustrates exemplary iFISH symbols and the relationship of the symbol to one characteristic, namely, the size (in bytes) of the document or email message.

In one embodiment, when an iFish 120 is deleted from a user's Send or Inbox folders it does not go to the Deleted folder. Rather, the document or message is permanently deleted. The iFish5 system 10 also prompts users to empty their trash/recycling bin periodically to further reduce storage inefficiencies. The iFish5 system 10 prioritizes deleted iFish as these are the best candidates for rapid deletion. It should be appreciated that the iFish5 system 10 also includes a recovery mechanism such that, for example, if a user inadvertently deletes one of the iFish 120 by mistake they can select/click a Recover button 140 and recover the document or email.

In one embodiment, the iFish5 system 10 is configured to prioritize deletion of documents and email messages via one or more characteristic or parameter 70. The characteristic or parameter 70 may be set by an administrator of the iFish5 system 10 or on a user-by-user basis. In one embodiment, the characteristic or parameter 70 includes, for example, size of the document or email message (e.g., a predetermined size in megabytes), age (e.g., a predetermined number of days left unreferenced), priority (e.g., low versus high priority), and content (e.g., administrative information broadcast to all users on the system versus a message that was specifically addressed to an individual user, or a document/message including advertising content versus a document/message having valuable business information and data). In some cases, for example, a large document or email message (high megabytes) may be low priority and, thus, be an ideal candidate for deletion.

Upon reallocation (to a secondary memory device that is not backed up) or deletion of one of the iFish 120 a character image pops up with a different message depending on the percentage of total storage that was saved. For example, in one embodiment, a Sea Captain Cleanup may appear to say, “Brilliant—you just eliminated 3% of your total iFish stored! Keep going.” “Guess what? You just moved into the top 100 Anglers!” It should be appreciated that it is within the scope of the present inventor to present a number of informative or motivational messages to users to encourage the users to keep going and continue to “clean up” their information and data repositories 50.

The iFish5 system 10 also searches and identifies related or twin document or emails. For example, this could be an email with an identical attachment in both the Sent and Deleted folders of the SCID folders. In one embodiment, extra points are provided for catching twins, triplets, etc.

6. Keeping Score: As the user catches email/iFish a meter 150 shows how many iFish 120 he/she has caught in megabytes and as a percentage of total information and data stored. The user can also see how many and how much documents and emails have been reduced over a baseline and for how many months. In accordance with one aspect of the present invention, a “Fishing Contest” metaphor can run within an organization in any time interval. In one embodiment, a preset time period of, for example, twice a year for two to six month period, is provided. A leader board 160 shows, for example, a list of the top five (5) anglers at any one time and the amount of email they have deleted. In one embodiment, a corporation may make the top anglers eligible for additional awards, e.g., a bonus day away from work, corporate merchandise, and the like, an incentive to all employees.

7. Levels: As noted above, in one embodiment the iFish5 system 10 is implemented as a Fishing Contest. In one embodiment, the contest includes ranking employees within one of a predetermined number of levels. For example, employees may start at a beginner level and over the course of the contest, e.g., a next six months, the employee may move up as they consistently fish out the big document and emails stored in their respective folders. In one embodiment, the iFish5 system 10 includes five (5) skill levels such as, for example:

a. Beginner: Reduces amount of documents and email stored by 25% for 1 month;

b. Angler: Reduces amount of documents and email stored by 35% for 2 months;

c. Angler Pro: Reduces amount of documents and email stored by 45% for 3 months;

d. Angler Pro Master: Reduces amount of documents and email stored by 55% for 4 months;

e. Angler Ultra Pro Master: Reduce amount of documents and email stored by 65% for 6 months.

As can be appreciated, it is within the scope of the present invention to include more than the aforementioned levels or no levels at all.

8. Rewards: Organizations can offer rewards for employees who reach a particular level or the iFish5 system 10 can print out certificates at each level. Rewards can range from, for example, cafeteria coupons, to desirable books such as “The Hamster Revolution: How to Manage Your Email Before It Manages You,” by Mike Song, Vicki Halsey, and Tim Burress, cash incentives, to other forms of organizational-wide acknowledgements.

9. Timing: In one embodiment, the iFish5 system 10 includes a timer 170 exhibited on the interface 110 as, for example, a clock, that counts down from a predetermined time of, for example, five (5) minutes, to zero insuring that the user spends no more than the predetermined time per week playing the iFish fishing game. The timer function is also seen to provide a sense of urgency to the game. When the clock 170 reaches zero the employee can continue for another predetermined time period of, for example, five (5) minutes but after that the iFish5 system 10 turns the Fishing Contest off. One perceived advantage of this timer functionality is to level the playing field for all corporate personnel.

10. Enterprise Dashboard: The iFish5 system 10 tracks individual and group performance with a dashboard that allows administrators to see how many documents and email message and how much storage has been deleted and reallocated over each contest period. All dashboard info can be easily downloaded into spreadsheet reports. In one embodiment, the dashboard charts, for example:

a. Total documents and email stored

b. Documents and email reduced in megabytes and as a percentage of the starting total

c. Trends over time for documents and email stored

d. All anglers and their respective scores and angler levels

e. Number of anglers active, etc.

In one embodiment, the iFish5 system 10 also allows administrators to bypass users who may need to be removed from a contest for one reason or another. The iFish5 system 10 can be programmed to select “winners” and it can be linked to various reward point systems and incentive programs such as, for example, Corporate Ace Points, and the like.

11. Education: The iFish5 system 10 also periodically teaches users the value of what they are doing. For example, the system explains the benefit of cost savings and improvement in speed and performance that result from not overloading servers and other computing devices with unnecessary document and email storage and backup.

12. Time to Play: In one embodiment, an icon is presented on a user's display device, for example, on the user's lower toolbar, to indicate a status of the user's electronic document and email storage. For example, in one embodiment, the icon begins to pulse and turn red when document and email volume exceeds a predetermined threshold such that it is relatively “high” with respect to a desired volume, or when the user hasn't played the game within a predetermined time period of, for example, about one (1) week. After a second time period, of about two (2) weeks, a pop up window reminds the user that it is time to “go fishing.” After that second time period, the iFish5 system 10 may periodically provide a humorous reminder on a more frequent basis that email cleanup is required.

13. Catchy Name and Number: The inventor believes that the foregoing game metaphor and “branding” approach to a document and email reduction program is unique. Similarly, the number five (5) is used in as many ways as possible to emphasize basis premises within the game metaphor, for example, the ninety-five to five percent (95%-5%) rule, the five (5) minute time limit, the five (5) skill levels, etc.

14. Variations of the metaphor of the iFish5 system 10: It should be appreciated that it is within the scope of the present invention to expand the novel document and email reduction program beyond the illustrated “fishing contest” metaphor. That is, the novel document and email reduction program encompass any number of metaphors for blending a fun, rewarding game with the seemingly dull task of reducing SCID folder back up and storage requirements. For example, the inventor envisions several variations of the illustrated “fishing” theme of a reduction program including, but not limited to, the following other metaphors.
a. iBall5: Instead of fish, document and email are represented graphically by balls of varying size and color. The user uses their mouse to pop the balls in order to see if they can be deleted.
b. iGold5: Instead of fish, document and email messages are represented graphically by various forms of precious metal. For example, large nuggets of gold are the most valuable because they represent the biggest document and emails (largest size in terms of bytes of storage). Here the fish finder is replaced with, for example, a metal detector or other piece of miner's equipment such as a miner's sieve or screen to pan for various sized nuggets traversing the screen as if in a mountain stream.
c. i5 (Generic Version): For those who do not like games, a generic version is available that simply brings up the top five (5) largest sized (in bytes) emails for the user to review. Some users may gravitate to this mode after they are indoctrinated into the game metaphor as it may well be the fastest way to purge the most information. It is anticipated that Generic Version users will be those people who really want to win the game, but who no longer need the animation to remain engaged. A variant of the Generic Version is a stripped down version of the game in which a predetermined number of the largest/oldest/least touched files are automatically off loaded to another site on the user's computer, organization's network servers, or a compression/zip folder that shrinks the size of the files. Essentially they can be offloaded to anywhere but a place that needs to be backed up each night. If the user really needs the documents they can be retrieved for a predetermined time period of, for example, ninety (90) days after the procedure, but essentially all the user has to do is click “OK” for these folders to remain deleted. If the users believe that they need the documents, they are prompted to save them elsewhere with the very last option being that they leave them where they are in a location that is periodically backed up such as a SCID folder. If they do leave them, the system 10 highlights them and places them at the top of their reflective folder and a mirror image of them is stored in an iFish5 email folder in plain view thus allowing them to attack their biggest emails all at once and points are scored when items in this folder are deleted. The folder name changes to show the total MBs contained within.
d. iTarget5: In this embodiment, a “target practice” shooting metaphor is employed in which documents and email messages appear to float across the screen represented as various size circular targets. The user uses his/her mouse (e.g., displayed graphically as cross-hairs) to point a virtual gun and shoot at the targets. Rewards are given for hitting the largest or most targets.
e. It should be appreciated that it is within the scope of the present invention to employ a number of other metaphors within a document and email reduction program.

15. Related Software modules: The inventor envisions additional software modules that may be incorporated within the document and email reduction program to even further increase productivity. Modules include, but not limited to:

a. Power Drafts: A handy system for pasting repetitive document, email and meeting verbiage into various documents including meeting invites, emails, and task entries.

b. Info-X Dashboard: A dashboard of useful statistics on document and email usage including the number of emails sent, received, etc. and the general overall trends for document and email usage by individuals, or within groups such as teams, departments, business units and enterprise wide.

c. Modules for all Cohesive Knowledge Solutions, Inc.'s (CKS) workshops including Email Efficiency and Etiquette, File and Find it Fast, and Making Meetings Matter as well as CKS books such as, “The Hamster Revolution, versions 1 and 2.”

d. COTA Installation Software.

It should be appreciated that it is also within the scope of present invention to employ the iFish5 system 10 to manage other electronic storage areas. That is, the inventor envisions additional uses for the novel system and method described heretofore for identifying and removing large electronic documents and email messages (email) to reduce storage requirements and thus, more efficiently utilizing storage devices. For example, the inventor envisions use of the iFish5 system 10 to assist organizations that are struggling to reduce outdated documents on their individual document drives such as within “My Documents” folders on personal computers as well as on shared and/or networked drives, which might include, for example, Microsoft Sharepoint, Documentum, Livelink, or standard shared drive folders containing electronically stored documents in word processing (e.g., Word), image formats (PDF), PowerPoint presentations, spreadsheets, and the like. As can be appreciated, it is expensive and time-consuming for information technology departments to determine which documents should be deleted. It also very expensive to continually back up documents and other electronic information within these storage areas. One significant issue is encouraging people to locate and delete their “useless” documents.

In one aspect of the present invention the iFish5 system locates data and information based on other characteristics (e.g., not just storage requires or content). For example, a set number of older (based on predetermined time period from creation or last access), high Megabyte, unused documents “owned” in some way by a designated user each week (e.g., a predetermined set number of documents is five (5) such documents) from collaborative shared document repositories that belong to the user. In one embodiment, criteria for candidate data and information, hereafter “candidate documents” includes, but is not limited to, the following kinds of documents created or used by the user:

1. Old documents (documents created a predetermined time period from a current date).

2. Unopened, dormant documents (documents that have not be accessed for a predetermined time period from a current date).

3. Documents that do not contain content subject to Legal Hold (e.g., a legal or procedural requirement that the document be maintained in an electronic format for a predetermined period of time).

4. Low Priority Documents

5. Documents only opened by the user

6. Documents created by the User

7. Documents that exceed a predetermined size (e.g., large megabyte documents).

8. Documents pertaining to outdated topics.

In one embodiment, the iFish5 system 10 presents a user with an interface that describes the document, it's relative size as compared to other stored documents, document priority level, a last time the document was opened, etc. From the interface, the user can open and inspect the document, and then decide to let it be deleted or to keep it.

In either case, the document is not actually deleted until the user makes a decision. If two or more users have accessed the documents—those users will each be asked individually if the document can be deleted. If all users agree that the document is not needed, the document is deleted.

In this scenario, the iFish5 system 10 assists an organization with one thousand (1000) employees locate and delete, for example, about ten Megabyte (10 MB) of storage per user per week, could reallocate about five hundred twenty (520) gigabytes of data that no longer needs to be backed up each year. Over a five-year period, this percentage of storage savings would be about 2.5 terabytes of information that would not be on the servers in need of back up.

It should be appreciated that in both an email and in a document management scenario, the iFish5 system 10 presents a user a means of seeing the email message or document in the context of its relationship within the computer of the user. In other words, the user can also see the file folder path that leads to the document before agreeing to delete it. This presentation of the “storage path” provides contextual information that helps a user make a more informed decision to delete or not delete a particular email message or document.

It should be understood that the present invention is not limited with regard to the metaphor utilized to realize an email or document reduction program. Accordingly, although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method of managing electronic data and information to maximize efficient storage thereof, the method comprising the steps of:
categorizing documents and electronic mail messages including the data and information present in a plurality of primary storage devices or locations in relation to a storage requirement of each of the documents and electronic mail messages;
invoking an interactive metaphor by which a plurality of users selectively identify subsets of the categorized documents and electronic mail messages; and
when identified, reallocating the subset of documents and electronic mail messages by at least one of storing the subset of documents and electronic mail messages in a secondary storage device or location and deleting the subset from plurality of primary storage devices or locations.

2. The method of claim 1, wherein the plurality of primary storage devices or locations are comprised of electronic mail Sent, Calendar Inbox, and Deleted (SCID) folders.

3. The method of claim 1, wherein the interactive metaphor is comprised of a fishing metaphor.

4. The method of claim 3, wherein the electronic mail messages are categorized as a plurality of fish including at least one of a mega whale for email>5 MB in size, a killer whale for email>3 MB<5 MB in size, big shark for email>1 MB<3 MB in size, a small shark for email>500 Kb<1 MB in size, and a minnow for email>10 Kb<500 Kb in size.
